(19) United States
(12) Patent Application Publication
(10) Pub. No.: US 2024/0254832 A1
(43) Pub. Date: Aug. 1, 2024

(54) Barrier Gate for Pets and Babies with Integrated Safety Features

(71) Applicant: ALAA ABI JOMAA, NEPEAN (CA)

(72) Inventor: ALAA ABI JOMAA, NEPEAN (CA)

(21) Appl. No.: 18/102,143

(22) Filed: Jan. 27, 2023

(51) Int. Cl. E06B 9/01; F21V 33/00; H05B 47/105; H05B 47/165

(52) U.S. Cl. CPC E06B 9/01; F21V 33/0004; H05B 47/105; H05B 47/165; E06B 2009/002; F21W 2111/00; F21Y 2103/10; F21Y 2115/10

(57) ABSTRACT

The present disclosure provides a barrier gate with integrated safety features to ensure the safety of any pets, babies, and young children trapped on one side of the gate in the event of an emergency such as a fire. To this end, the barrier comprises a gate with an electronically operable locking mechanism which is opened automatically in response to a detection from a sensor indicating an emergency. The barrier gate is self-contained with its own power source and can be installed across any passageway in a home due to having modular wall elements. A number of lighting elements and speaker device may be incorporated, both to provide guidance in an emergency and to alert adults to the gate being opened in the event of false alarms.

### FIELD OF INVENTION

The present invention relates generally to a barrier gate for pets and babies. More specifically, the present invention relates to a barrier with a gate configured to open automatically in emergency situations.

### BACKGROUND

It is beneficial in many situations for people to install safety barriers across various passageways of their home to prevent babies, young children, and pets from passing through the passageways. This prevents them from escaping and moving through areas where they could do themselves harm, such as down a flight of stairs. Baby gates and pet gates for achieving this are well known in the art, providing barriers with manual opening mechanisms that are only operable by an adult human, who would be in no danger from passing through.

However, in the event of an emergency such as a fire in the home, these safety oriented devices turn into lethal traps, preventing pets and babies alike from escaping the danger on their own. Each year many pets and children are injured or even killed due to fires in the home. According to recent statistics, there are over 350,000 domestic fires in the United States every year. Tragically, these fires often result in the injury or death of children and pets who were unable to escape. Regular baby and pet gates, while useful for keeping little ones contained, can actually act as barriers and obstacles, hindering children and pets from escaping to safety.

Prior art solutions have been proposed that automatically or semi-automatically unlock a door for a pet or child to escape from a detected fire, however there is no available solution for applying this concept to a gate which can be installed across doorways and hallways like a regular baby gate. Known solutions are all integrated with existing doors, limiting their versatility, and often rely on communication with an existing fire detector.

There is a need for a baby or pet gate with integrated safety features that provide the ability to control movement of pets or babies through any passageway in a home without preventing them from escaping during a fire.

It is within this context that the present invention is provided.

### SUMMARY

The present disclosure provides a barrier gate with integrated safety features to ensure the safety of any pets, babies, and young children trapped on one side of the gate in the event of an emergency such as a fire. To this end, the barrier comprises a gate with an electronically operable locking mechanism which is opened automatically in response to a detection from a sensor indicating an emergency. The barrier gate is self-contained with its own power source and can be installed across any passageway in a home due to having modular wall elements. A number of lighting elements and speaker device may be incorporated, both to provide guidance in an emergency and to alert adults to the gate being opened in the event of false alarms.

According to a first aspect of the present disclosure, there is provided a baby/household pet barrier gate with integrated safety features, the barrier gate comprising: a plurality of modular wall elements each configured to couple to one another to form a barrier of a desired length; two or more mounting mechanisms for securing either side of the barrier formed by the wall elements across a passage in a home.

The barrier further comprises a gate frame configured to couple on either side to one of the wall elements, the gate frame comprising: a gate mounted in the frame and coupled to a first side of the gate frame by a hinged joint; at least one sensor for detecting an indication of a fire hazard; a power source; an electronically operable locking mechanism configured to secure the gate in a closed position when engaged with a latch on an opposing second side of the gate element; a spring disposed on the second side of the gate element, the spring being arranged, upon the locking mechanism becoming disengaged form the latch, to cause the gate to swing open towards a first direction; and a controller, the controller being configured to, upon receiving an alarm signal from the sensor, automatically cause the locking mechanism to disengage from the latch.

In some embodiments, the at least one sensor comprises a heat detector, a smoke detector, or an audio sensor configured to detect an alarm sound.

In some embodiments, the barrier further comprises one or more lighting elements disposed on the gate and which are operated by the controller. The lighting elements may be arranged on the side of the gate which opens towards the first direction.

They may comprise a pair of LED strips arranged vertically on either side of the gate frame, and the controller may be configured, in response to a detection from the at least one sensor, to cause the LED strips to implement a sequential lighting pattern so as to indicate to users on that side of the barrier where the gate is.

The one or more lighting elements may also comprise an LED light positioned on the locking mechanism, and the controller may be configured, in response to a detection from the at least one sensor, to cause the LED light to perform a strobing pattern.

In some embodiments, the barrier further comprises a speaker device operated by the controller, and wherein the controller is further configured, in response to a detection from the at least one sensor, to cause the speaker device to emit an alarm sound.

In some embodiments, the gate frame further comprises a manual release handle for operating the gate in non-emergency situations. The locking mechanism may be configured to prevent the gate from being closed again after a detection from the at least one sensor causes the controller to open the gate, until the manual release handle is operated.

In some embodiments, the two or more mounting mechanisms comprise extendible tension bolts disposed on the outer edges of the barrier for installing the barrier between a pair of opposing walls. The tension bolts may comprise cushioned outer surfaces to prevent the barrier from damaging the walls during installation or operation.

### BRIEF DESCRIPTION OF THE DRAWINGS

Various embodiments of the invention are disclosed in the following detailed description and accompanying drawings.

FIG. 1 illustrates a first isometric perspective view of an example barrier gate according to the present disclosure in a closed position.

FIG. 2 illustrates a second isometric perspective view of the example barrier gate in a closed position.

FIG. 3 illustrates an isometric perspective view of the example barrier gate in an open position.

FIG. 4 illustrates a components view of the modular wall elements and gate frame of the example configuration of the barrier gate.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terminology used herein is for the purpose of describing particular embodiments only and is not intended to be limiting. As used herein, the singular forms “a,” “an” and “the” are intended to include the plural forms as well, unless the context clearly indicates otherwise.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

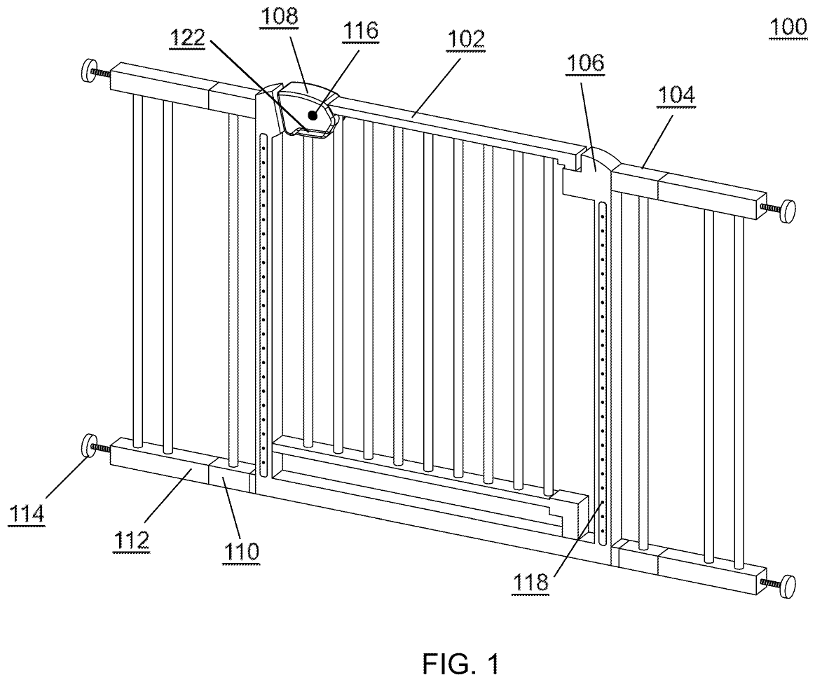

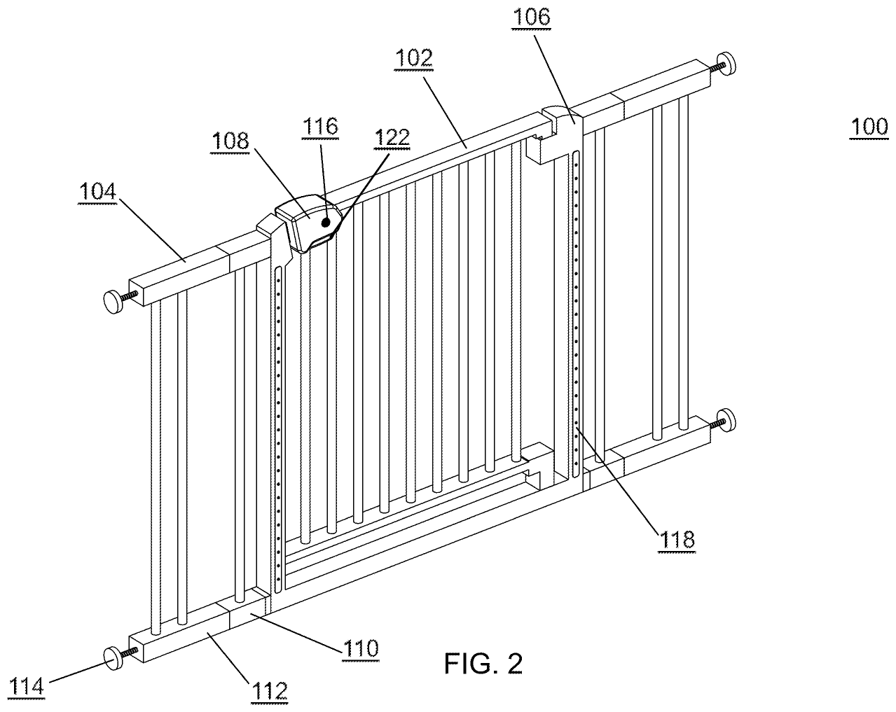

Referring to FIG. 1 and FIG. 2, isometric perspective views are shown of an example barrier gate 100 according to the present disclosure with the gate 102 in a closed position in its frame.

As can be seen, the barrier 100 is formed of a gate frame 102 installed between a plurality of modular wall elements 104, including a number of connecting wall elements 110 and pair of end wall elements 112 which are equipped with mounting mechanisms 114.

This arrangement allows the length of the barrier to be adjusted to suit the dimensions of any passageway in a home across which the user wishes to install it. Once an appropriate number of connecting wall elements 110 have been added to reach a desired length, the end wall elements 112 are connected and the mounting mechanisms, which in this case are a set of tension bolts 114 with cushioned ends to prevent damage to the walls of the passageway, are extended outwards to firmly secure the barrier in place.

The gate frame 102 is configured to couple on either side to one of the wall elements 104, and comprises a gate coupled to a first side of the gate frame by a hinged joint 106, allowing the gate to freely swing outwards in one direction when not secured by the locking mechanism 108 on the other side. In the present example the gate is configured to swing in the direction towards the reader out of the page.

The locking mechanism 108 is a smart lock which comprises several electronic components, and is the main safety feature of the disclosed barrier 100. Inside the locking mechanism housing 108 a sensor is configured to detect any indication of a fire—this could be a heat sensor, a smoke detector, an audio sensor for detecting an alarm, or any combination thereof. Other types of sensor suitable for detecting emergency situations may also be integrated in the lock.

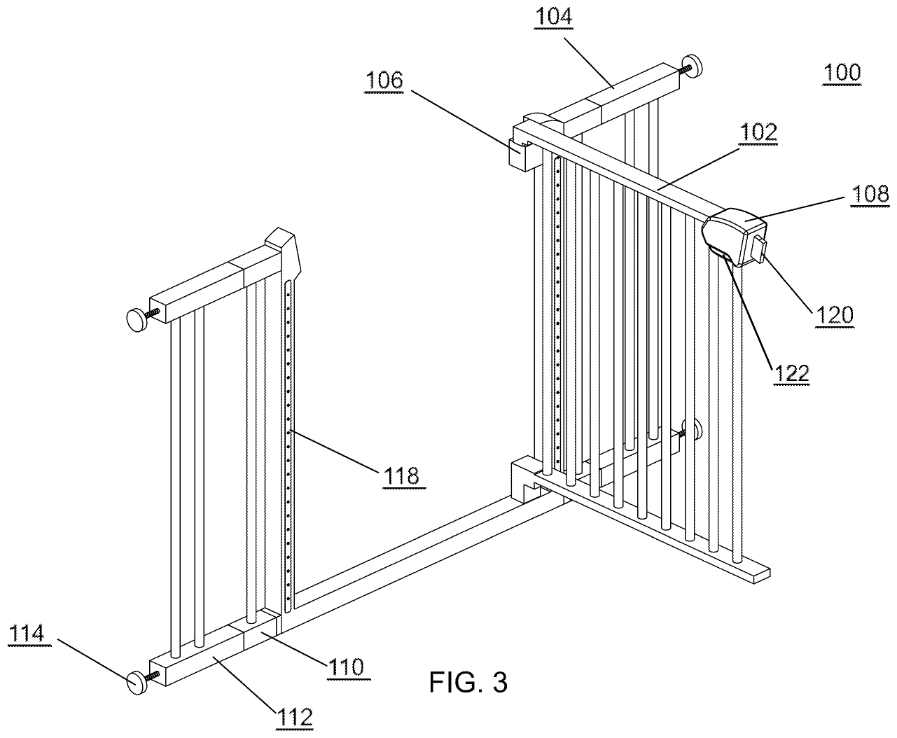

Referring to FIG. 3, an isometric perspective view is shown of the example barrier gate 100 in an open position.

The physical locking mechanism that controls the movement of the latch 120 is electronically operable and connected to a microcontroller which in turn is coupled to the sensor arrangement, such that any detection from the sensor that indicates an emergency, such as a heat or smoke level above a predetermined threshold, cause the controller to unlock the gate. The locking mechanism 108 also comprise a spring arrangement which is biased, when the gate is closed, to apply a spring tension force to open the gate automatically when it is unlocked. Thus, any detected indication of a fire will cause the gate to spring open and allow pets and babies to escape through the previously barred passageway. The barrier 100 comprises an integrated power source such as a rechargeable battery for powering these operations and the operations described below.

As mentioned above, barrier gate 100 also comprises a number of secondary safety features.

One problem with ensuring the gate opens in emergency situations is that, without implementing complex circuitry and control logic, it is difficult to avoid false alarms which cause the gate to open at undesirable time when there is no emergency. This would open a passageway to a pet or baby which the user wishes to keep blocked in most situations.

In order to compensate for this drawback, the barrier gate 100 can also be provided with a speaker coupled to the controller and which is configured to beep loudly in the event of the gate being opened automatically, alerting nearby adults to the passageway becoming open. This beeping can also help guide pets and children towards the gate in the even t of a fire where the surroundings are obscured by smoke.

The same effect can be achieved by arrangements of lighting elements coupled to the controller and configured to be switched on in the event of a sensor detection and lock disengage. As shown, the gate frame 102 has an LED lighting element 116 on the locking module. This can be turned on and performs a strobing effect in the event of a sensor detection, guiding the user towards it.

A pair of LED strips 118 on the gate frame perform a similar function. Even when the gate itself is opened these will not move, because they are positioned on the frame sides, and can thus act as a sort of runway guide, showing where the opening to go through is even through thick smoke.

These lighting elements are all arranged on the side of the barrier towards which the gate opens inwards. They are not as necessary on the opposing side, although may be included in some examples.

The locking mechanism 108 also includes, like most baby gates do, a manual release handle 122. This can be used by adults to open the gate in non-emergency situations, like any other baby gate or pet gate.

The gate may be configured such that, in the event of an emergency detection, the latch 120 prevents the gate from reclosing until the manual release mechanism 122 is actuated. This will prevent pets and children from accidentally re-closing the gate and trapping themselves on one side.

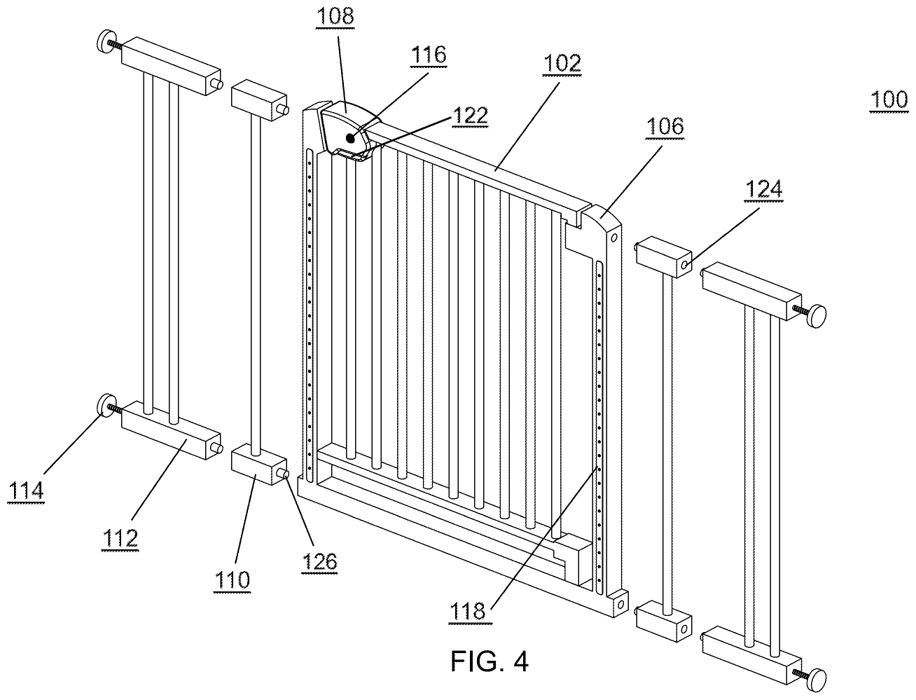

FIG. 4 shows the connector wall elements 110 and the end wall elements 112 separated from one another and the gate frame 102, and also shows an example of the modular connections therebetween with interconnecting protrusions 126 and openings 124.

The term ‘controller’ as used herein may refer to a simplified controller such as a microchip or integrated circuit board configured to carry out a set of predetermined actions. Other more advanced types of controller may also be used to provide increased functionality.

A controller may advantageously contain control logic, or program logic, or other substrate configuration representing data and instructions, which cause the computer to operate in a specific and predefined manner as, described herein. In particular, the computer programs, when executed, enable a control processor to perform and/or cause the performance of features of the present disclosure. The control logic may advantageously be implemented as one or more modules. The modules may advantageously be configured to reside on the computer memory and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro code, circuitry, data, and/or the like.

The control logic conventionally includes the manipulation of digital bits by the processor and the maintenance of these bits within memory storage devices resident in one or more of the memory storage devices. Such memory storage devices may impose a physical organization upon the collection of stored data bits, which are generally stored by specific electrical or magnetic storage cells.

The control logic generally performs a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, files, or the like. It should be kept in mind, however, that these and some other terms should be associated with appropriate physical quantities for computer operations, and that these terms are merely conventional labels applied to physical quantities that exist within and during operation of the computer based on designed relationships between these physical quantities and the symbolic values they represent.

It should be understood that manipulations within the computer are often referred to in terms of adding, comparing, moving, searching, or the like, which are often associated with manual operations performed by a human operator. It is to be understood that no involvement of the human operator may be necessary, or even desirable. The operations described herein are machine operations performed in conjunction with the human operator or user that interacts with the computer or computers.

It should also be understood that the programs, modules, processes, methods, and the like, described herein are but an exemplary implementation and are not related, or limited, to any particular computer, apparatus, or computer language. Rather, various types of general-purpose computing machines or devices may be used with programs constructed in accordance with some of the teachings described herein. In some embodiments, very specific computing machines, with specific functionality, may be required.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the barrier gate have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A baby/household pet barrier gate with integrated safety features, the barrier gate comprising:
a plurality of modular wall elements each configured to couple to one another to form a barrier of a desired length;
two or more mounting mechanisms for securing either side of the barrier formed by the wall elements across a passage in a home;
a gate frame configured to couple on either side to one of the wall elements, the gate frame comprising:
a gate mounted in the frame and coupled to a first side of the gate frame by a hinged joint;
at least one sensor for detecting an indication of a fire hazard;
a power source;
an electronically operable locking mechanism configured to secure the gate in a closed position when engaged with a latch on an opposing second side of the gate element;
a spring disposed on the second side of the gate element, the spring being arranged, upon the locking mechanism becoming disengaged form the latch, to cause the gate to swing open towards a first direction; and
a controller, the controller being configured to, upon receiving an alarm signal from the sensor, automatically cause the locking mechanism to disengage from the latch.

2. A barrier gate according to claim 1, wherein the at least one sensor comprises a heat detector.

3. A barrier gate according to claim 1, wherein the at least one sensor comprises a smoke detector.

4. A barrier gate according to claim 1, wherein the at least one sensor comprises an audio sensor configured to detect an alarm sound.

5. A barrier gate according to claim 1, wherein the barrier further comprises one or more lighting elements disposed on the gate and which are operated by the controller.

6. A barrier gate according to claim 5, wherein the one or more lighting elements are arranged on the side of the gate which opens towards the first direction.

7. A barrier gate according to claim 5, wherein the one or more lighting elements comprise a pair of LED strips arranged vertically on either side of the gate frame.

8. A barrier gate according to claim 7, wherein the controller is configured, in response to a detection from the at least one sensor, to cause the LED strips to implement a sequential lighting pattern so as to indicate to users on that side of the barrier where the gate is.

9. A barrier gate according to claim 5, wherein the one or more lighting elements comprise an LED light positioned on the locking mechanism, and wherein the controller is configured, in response to a detection from the at least one sensor, to cause the LED light to perform a strobing pattern.

10. A barrier gate according to claim 1, wherein the barrier further comprises a speaker device operated by the controller, and wherein the controller is further configured, in response to a detection from the at least one sensor, to cause the speaker device to emit an alarm sound.

11. A barrier gate according to claim 1, wherein the gate frame further comprises a manual release handle for operating the gate in non-emergency situations.

12. A barrier gate according to claim 11, wherein the locking mechanism is configured to prevent the gate from being closed again after a detection from the at least one sensor causes the controller to open the gate, until the manual release handle is operated.

13. A barrier gate according to claim 1, wherein the two or more mounting mechanisms comprise extendible tension bolts disposed on the outer edges of the barrier for installing the barrier between a pair of opposing walls.

14. A barrier gate according to claim 13, wherein the tension bolts comprise cushioned outer surfaces to prevent the barrier from damaging the walls during installation or operation.
